(19) United States
(12) Patent Application Publication
(10) Pub. No.: US 2009/0199684 A1
(43) Pub. Date: Aug. 13, 2009

(54) Metal lathe, core drill adaptor and rate of cut device for use with a standard drill press

(76) Inventor: Kenneth Lee Reeves, Durham, NC (US)

Correspondence Address: Kenneth Lee Reeves, 1714 Hillandale Rd., Durham, NC, 27705, US

(21) Appl. No.: 12/069,340

(22) Filed: Feb. 8, 2008

(51) Int. Cl. B23B 5/00

(52) U.S. Cl. 82/130

(57) ABSTRACT

The Metal Lathe, Core Drill Adaptor and Rate of Cut Device are simple lathing and drilling devices including a device that restricts the advancement of the drilling and lathing motions. These devices are attached to a most any common standard upright drilling machine in a secure method to allow a person with little or no experience to operate these devices.

### BACKGROUND OF THE INVENTION

1. Field of the Invention

The present invention relates to metal working and or machining of any materials requiring a change of diameter in any solid, round or hollow round materials by lathing, turning and or the drilling of holes in all shapes and sizes of materials regardless of configuration of that material, using a standard drill press as the power source and device used for the rotation of the materials or the cutting device.

2. Description of Related Art

Changing the shape of materials such as metal, wood, plastics or any other type of material has been the final goal in all aspects of trades and inventions for centuries. Lathing or reshaping of round materials by cutting away the unwanted portion of the shape. This is done by rotating or turning the material at a slow rate of speed then placing a stationary blade or cutting device onto the material with pressure. thereby removing that part of the material not wanted.

Also, the drilling of holes works on the same principal as lathing, or turning except the material remains in a stationary location and the cutting device rotates as pressure is being placed onto the drilling tool and that pressure is transferred onto the material being drilled, thereby producing a hole by cutting away unwanted material.

These processes requires a slow rate of cut, else damage may occur to the tools, the materials and to the person operating these devices.

One major problem associated with the lathing or turning of round materials is the standard lathing machine is an extremely large, heavy and very expensive machine to own or operate. This leaves the average hobbyist and inventor at a disadvantage while trying to produce a small and inexpensive item, thereby forcing this person to have the work done at a machine shop at great expense in comparison to the value of the item being produced.

It is sometimes imperative that an inventor or hobbyist get things done quickly and machine shops are usually very busy and would really rather do work that pays a great deal of money, so the small inventor or hobbyist's work usually gets put at the rear of the work list. This may take weeks or sometimes months away from the hobbyist or inventors time and very often the idea is lost in the process of waiting.

One problem associated with the drilling of holes with a standard drill press is drilling of the larger holes ranging from 11/16″ thru 2″ and larger. Although this is possible, there are extreme problems associated with the process.

Drill presses that are affordable usually have the capability of using drill bits up to ⅝″ and a standard drill bit cuts by removing all of the unwanted material from the intended hole thereby creating a great deal of friction or heat on the drill bit and the material. This induced heat makes the material extremely hot and difficult to drill, even with the smaller drill bits. Using cutting oil and or a coolant is always necessary when drilling to prevent damage to the bit and reducing the wear of the drill press and the motor that powers the unit. Now, when using larger drill bits, even if oil is applied, comes the extreme induced drag that is created by the larger surface being drilled and most often causes failure of the drill bit and damage to the motor of the drill press because of the extra work created by using the large drill bit. The using of these large drill bits are usually not recommended with these standard drills presses.

The most efficient way to cut a hole, especially in metal materials is to use a core bit cutter in place of a standard drill bit. The core bit is a tool designed to cut a hole into steel. It uses a series of sharpened teeth in a 360 deg. configuration. It also uses a centering pin that aligns with a center punched mark in the work material to cut the hole in the proper location. This is the most efficient method of cutting a hole available because this cutter removes only a small amount of material directly under the cutting teeth and produces a core plug as waste material and does not produce as much drill shavings as a standard drill bit does. This in turn reduces the drag and work load of the power source with a great savings of time, effort and money. Unfortunately this method of drilling is not available to be used by a standard drill press, but only with a magnetic base type machine, this magnetic base will only work on iron or steel, therefore drilling of holes in any other material is impossible and because of the incapability of magnetic attachment, and with the wide it's magnetic base drilling holes into small pieces of metal also is not possible. These core bit cutting devices are not available in a useable form that can be used with any standard drill press and there is a need for such a tool in today's market.

U.S. Pat. No. 5,782.591 issued Jul. 21, 1998 to Wilkinson, discloses a universal tool holding device that is attached to a rotating spindle device or drill press type machine that provides a tool holding arbor that does not become easily removed from said spindle. Stating that a drill press can only be used for cutting motions causing vertical forced to be applied to a work piece and tool. Also stating that a router bit, biscuit bit, or sanding stone could not be used effectively and force a person to buy expensive machinery.

U.S. Pat. No. 4,570,952 issued Feb. 18,1986 to Hembigner; Thomas; Stranahan, Phillip, discloses a fluid collect chuck being a self contained oiling system that is confined to the inside realm of a drill or spindle chuck thus feeding the cutting tool and work materials with oil.

U.S. Pat. No. 7,313,850 issued Jan. 1,2008 to Miller, discloses a compact economical, multi-axis, small parts machining tool and generally relates to the machining of small parts.

U.S. Pat. No. 4,823,656 issued Apr. 25, 1989 to Weil, describes a holding Tool assembly for a lathe turret that is an automatically re-laughable tool holder for use with a variety of machine tools.

U.S. Pat. No. 6,945,339 issued Sep. 20, 2005 to Hiranuma discussed a core drill device use to bore holes

U.S. Pat. No. 6,929,434 issued Aug. 16, 2005 to Prokop, discloses a rotor cutting tool described as a drill with main cutting edges in a radial pattern.

U.S. Pat. No. 5,803,678 issued Sep. 8, 1998 to Korb, Holston, Hampton discloses a core drill device with multiple teeth arranged in a circular pattern with a centering device attached.

U.S. Pat. No. 4,664,565 issued May 12, 1987 to Palm, describes a drilling device with a core type tool in the chuck and a lever that creates the pressure installed onto the drilling device.

U.S. Pat. No. 5,960,531 issued Oct. 5, 1999 to Mora, O'banion, Palla, Welsh, shows a tool holding device mounted onto the work base of a standard drill press with an arrangement of tool locations.

U.S. D497,622 S issued on Oct. 26, 2004 to Huang, describes a device attached to a standard drill press at the work base of the drill press.

U.S. Pat. No. 5,765,455 issued Jun. 16, 1998 to Muhlnickel, describes a lathering device set on a horizontal plane with multiple controls for operating the machine.

U.S. Pat. No. 5,316,418 issued May 31, 1994 to Masaaki, Miyanaga, discloses a core type drilling device with multiple locking bit and spring loaded centering pin and appears to be used in a vertical type spinning or drilling device.

None of the above inventions and patents, taken either singly or in combination, is seen to describe the instant invention as claimed.

### SUMMARY OF THE INVENTION

The metal lathe (ML), core drill adaptor (CDA) and rate of cut device (ROCD) for use with a standard drill press, is a combination metal lathe (ML) and precision core drilling adaptor (CDA) with an automatic rate of cut device ((ROC) which may be used with most all standard drill presses. The lathe (ML) portion attaches to the drill press work base with two bolts. Position adjustments are partially made with these bolts. Other position requirements are accomplished with adjustments build into the drill press itself. The (CDA) portion is mounted into the chuck of the drill press and tightened with a chuck key. There also is an holding device that is incorporated into the inventions base, that holds the work material in a central location to prevent movement of the material and is designed to accept a Varity of diameters. The (ROCD) is a gas pressure operated device that is intended to advance or restrict the rate at which the material is lathed or drilled. These devices are attached to a standard drill press and in combination performs the following functions.

The (ML) works in conjunction with the (ROCD) to turn or cut down any piece of round, rod shaped material to a specific size by rotating the cutter blade adjustment knob clockwise which drives the cutter blade into the work material while the material is rotating. Also the lathe cutter head possesses a cutter blade guide with attached springs which are anchored to the main cutting head to overcome vibration and chatter produced while lathing hard materials and also makes the cutter blade easily adjustable. There are four adjustable set screws on either side of the cutting blade to prevent a rolling motion and lost motion of the blade while letting the blade move free laterally. The entire cutter head is also offset at a 5 deg angle to produce a better cutting angel and to help reduce vibration. The (ROCD) may be adjusted to force the chuck portion of the drill press to descend vertically along with the material that is being worked, thus causing a longitudinal cut to be made in the steel or other material while the rate of speed is controlled by a restrictor cylinder with adjustment valve. A single full 360 deg. rotation of the adjustment knob, clockwise, on the lathe will advance the cut approximately 0.060 of an inch in latitude, and has a capacity to cut ½″ or 0.500 of an inch in depth. The longitude of the cut being a maximum of about 6″ at a controlled rate. The material or round rod may be chucked into the drill press to produce the rotation necessary to cut the material or the material may be held in the (CDA).

A standard drill press usually has a maximum of ⅝″ material capacity at the chuck so the (CDA), having a variety of size capacities, is necessary when turning materials larger than the capacity of the drill press chuck. The core drilling process produces a byproduct slug bushing that is very useful around the shop when used as a spacer bushing, and the (CDA) may be used as a tool to produce this product. The (CDA) also has a spring loaded knock out pin for the extraction of the waste plug when drilling of the hole is complete.

Also, the (CDA) supplies the work material with oil and coolant fluid through the attachment of an oil and coolant device, and supplies necessary lubricant to keep the material and tools from being overheated while being lathed or drilled. This is especially true with stainless steel material being turned or drilled since stainless steel is very difficult to drill or lathe when it is heated up. The (CDA) has a tank mounted onto it's shaft that rotates with the device and feeds the material with coolant and oil thru a system of holes and slots inside the (CDA), and while working with stainless steel also feeds the work material with a combination of ice water, alcohol, and oil at 33 deg. Fahrenheit. When full of fluid the oil and coolant tank also provides the extra function of acting as a harmonic balancing device that helps overcome the natural vibration or chatter while drilling and lathing is in progress.

Accordingly, it is a principal object of the invention to provide a combination metal lathing, hole drilling adaptor device and rate of cut device with practical functions and with bushing making capabilities.

It is a further object of the invention to provide a plurality of a drilling, lathing, and (ROC) device that is capable of attaching to most all standard drill presses on the market today.

It is a further object of the invention to provide components in the invention to enhance safety, durability, efficiency and cost effective machining and lathing at a reasonable cost to the owner.

It is an object of the invention to provide improved elements and arrangements thereof in an apparatus for the purpose described which is inexpensive, dependable and fully effective in accomplishing its intended purpose.

These and other objects of the present invention will become readily apparent upon further review of the following specifications and drawing.

### BRIEF DESCRIPTION OF THE DRAWINGS

FIG. 1 is front environmental, perspective view of a metal lathe 100 & 200 and core drill adaptor 300 with oil and coolant tank 310, with a rate of cut device 400, which in whole is generally shown as 1000 in the drawings, being shown attached to a standard drill press 600.

FIG. 1A is an front environmental view of the metal lathe 100 &200, oil tank 310 and core drill adaptor 300 showing related parts of the invention.

FIG. 1B is an top view 100&200 and side view 100&200 of the metal lathe portion of the invention, showing related component parts.

FIG. 1C is an exploded view of the cutter head assembly 200 and the lathe 100&200 portion of the device and all the related parts.

FIG. 1D is an environmental view showing the invention 1000 including the rate of cut device 400 with all of its related component parts.

FIG. 1E shows the rate of cut 400 device seen in it's motion of work.

FIG. 1F shows the all of the component parts of the rate of cut device 400.

FIG. 2 is an environmental view that shows the core drill adaptor 300&310 with a core drill 54 cutting device in the core drill adaptor chuck 24 with work material 700, shown expelling the related waste plug 53, also shows all related parts for the core drill adaptor 300&310.

FIG. 2A is and exploded view of the core drill adaptor 300 without the oil and coolant tank. All related parts are shown for the core drill adaptor 300only.

FIG. 2B is an exploded view of the oil and coolant tank 310 and all it's related parts.

### DETAILED DESCRIPTION OF THE PREFERRED EMBODIMENTS

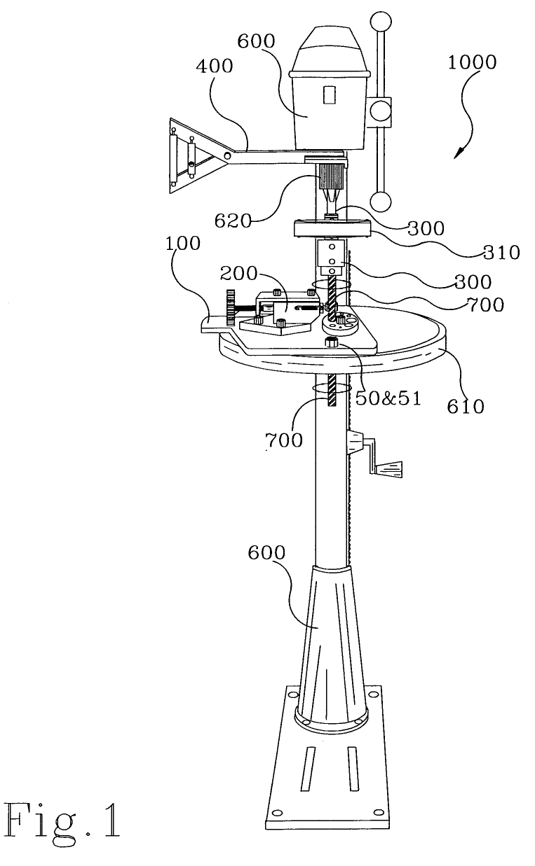

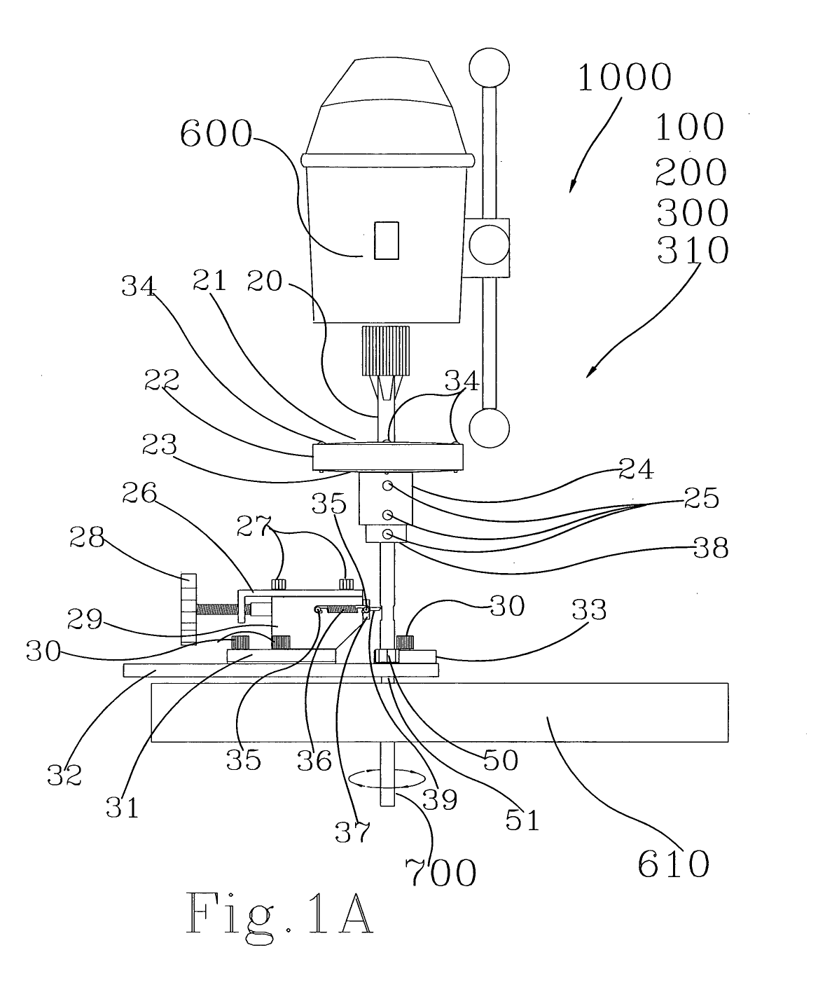

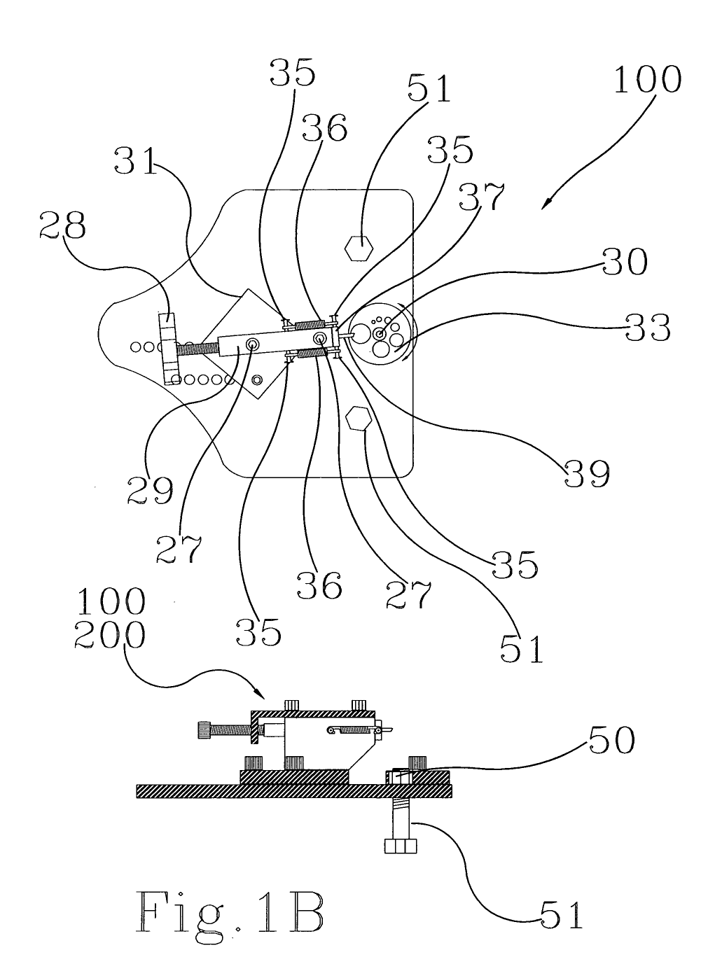

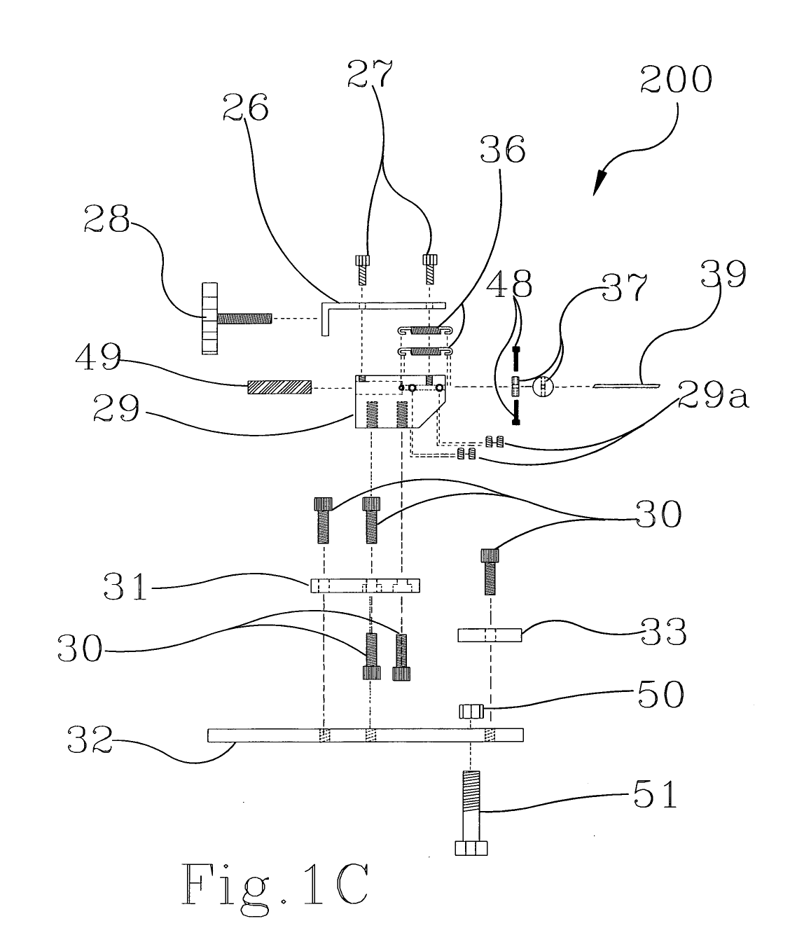

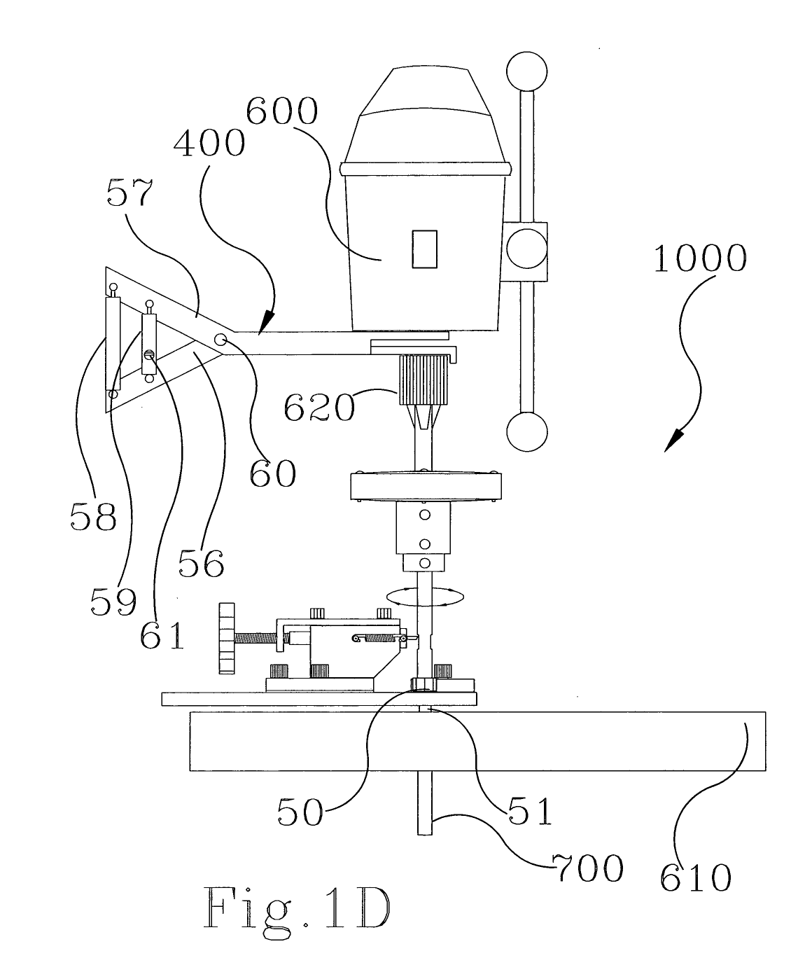

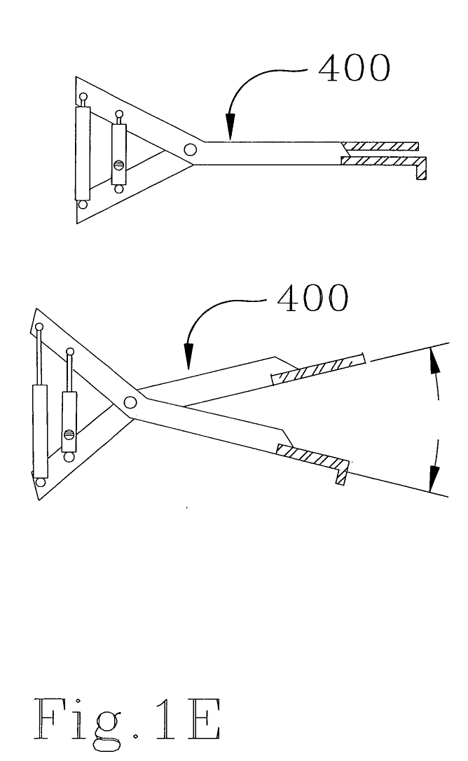

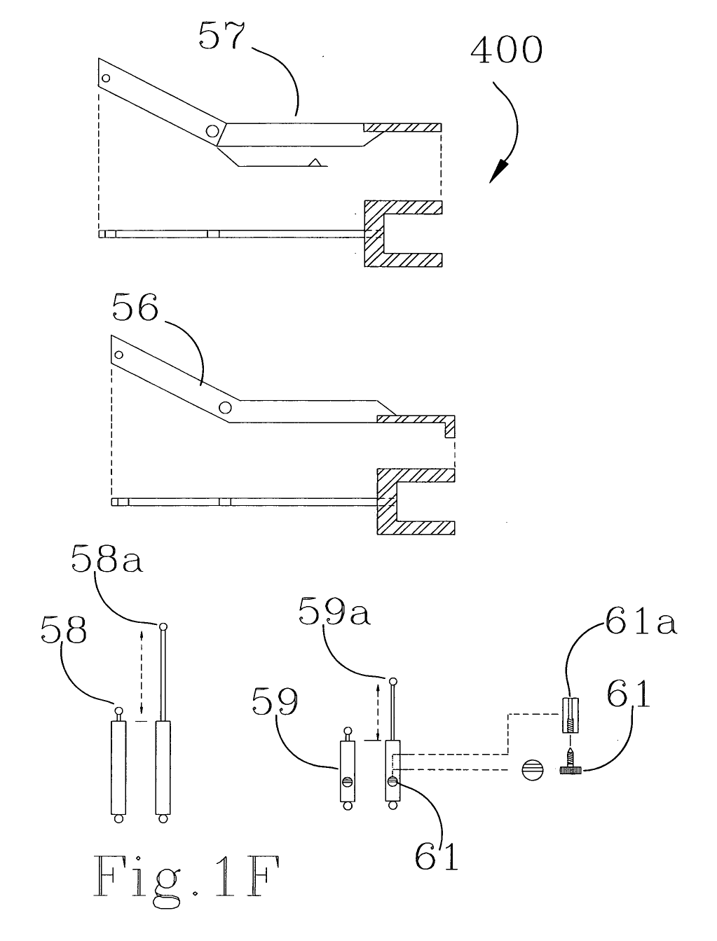

The present invention is a metal lathe (ML) 100 & 200, core drill adaptor 300 and rate of cut device (ROC) 400 being combined as 1000 is shown in FIG. 1 with a rate of cut device (ROC) 400 and a oil and coolant device 310 shown attached to a standard drill press 600 showing a drill press chuck 620 holding the core drill adaptor (CDA) 300 with the oil and coolant device 310 while the metal lathe (M) 100& 200 is shown in motion turning work material 700. The metal lathe (ML) 100&200 is shown mounted onto the drill press work base 610 with (2) two ⅝″ mounting bolts 51 and nuts 50.

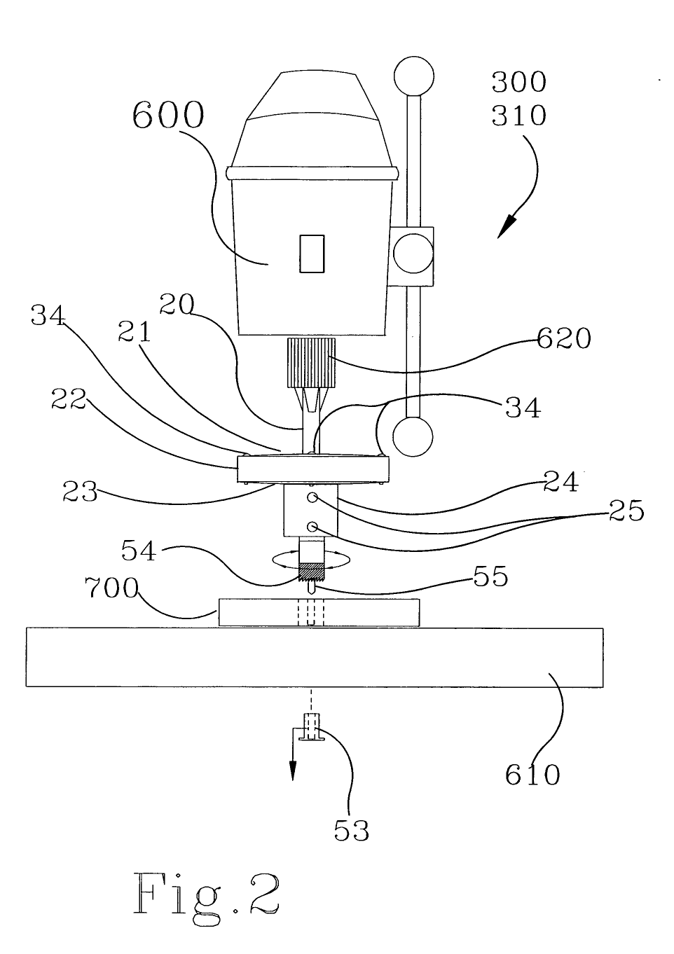

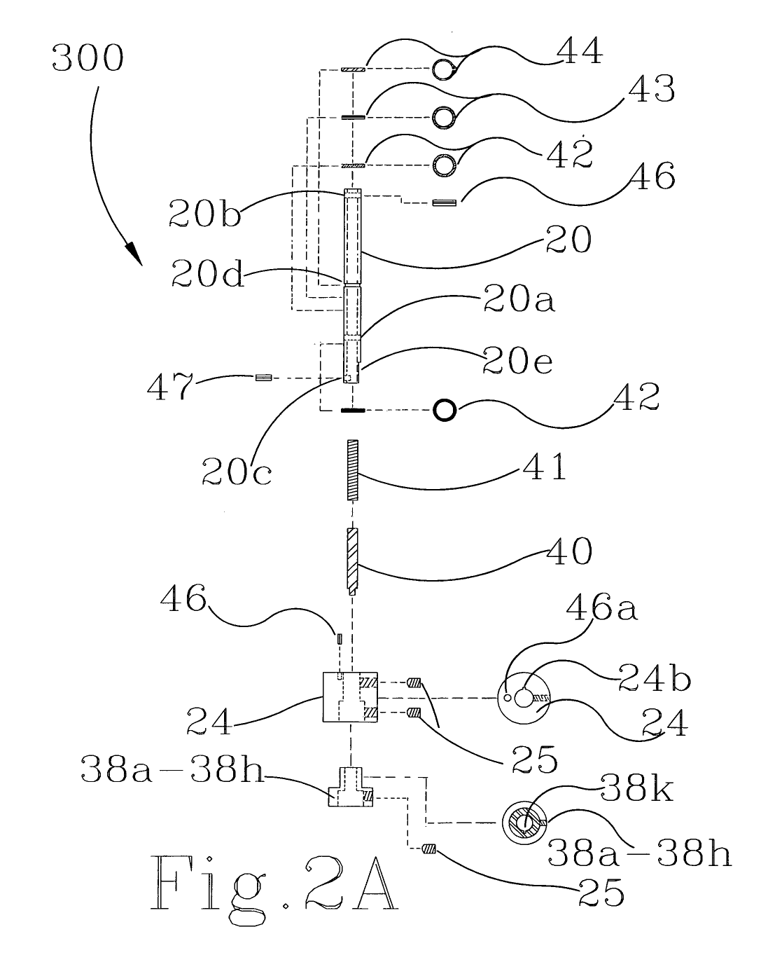

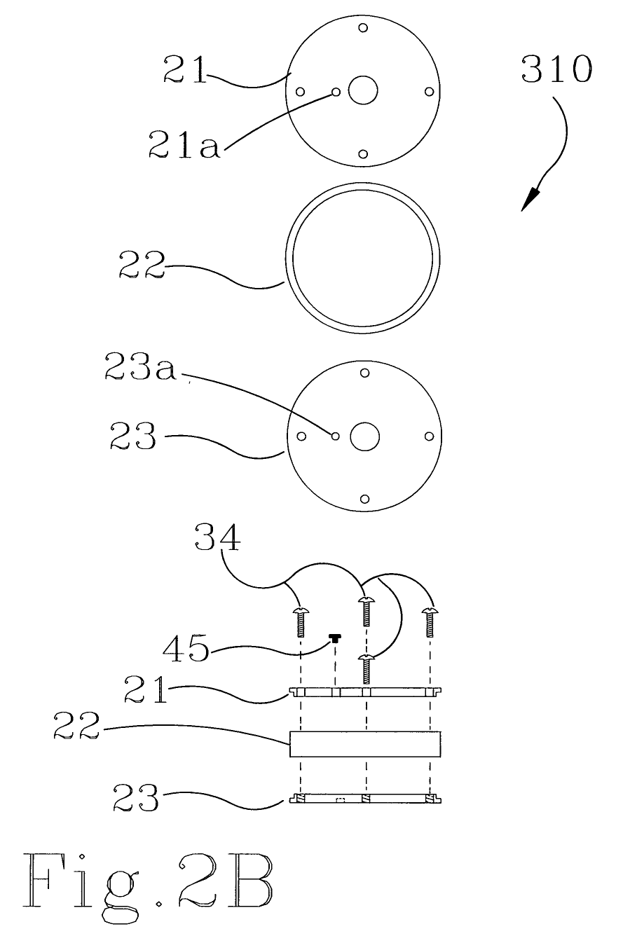

FIG. 1A is showing component parts of the metal lathe and core drill adaptor 1000, and it's component parts being as follows, main shaft of the core drill 20 transfers the power of the drill press to the core (CDA) 300 which serves as a material holder also, top cover of the oil and coolant tank 21 is sealed to the main body of tank and provides access to refill the tank with fluid thru a hole in the top, main body of oil coolant tank 22 is the reservoir to hold oil and coolant fluid, bottom cover of the coolant tank 23 is sealed to the main tank to create water tight unit and has a partially drilled dimple that fits onto a roll pin (46) on the top of the coupler 24 to force rotation of tank 310 at the same rate as the shaft. The core drill bit 54 seen in FIG. 2 is held by this material adaptor 24, coupler, material adaptor 24 also holds material adaptor 38a-38h seen in FIG. 2A, set screws 25 lock the main shaft 20 to the coupler 24 and also locks the core bit 54 and or work material 700 firmly into place in the coupler 24.

FIG. 1B shows a top view of lathe 100 and all sub components of 100&200, attention should be paid to material holder 33 for clarity and to point out 360 deg rotation and multiple hole configuration, that allows a verity of materials to be used with the (CDA). The cutter head 100,200 is adjustable laterally on the base plate 32 using a series of holes allowing front to rear adjustments, these adjustments along with other adjustable parts of the drill press(600) allows any position to made to work the invention.

In FIG. 1C the threaded adjustment bracket 26 holds the adjustment knob 28 in an exact location, bracket hold down bolts 27 hold the bracket 26 in place to the cutter head 200 seen in FIG. F1, cutter blade adjustment bolt and knob 28 being turned clockwise asserts pressure onto the guide pin 49 shown on FIG. 1C which in turn asserts pressure onto the cutting blade 39 forcing blade into work material 700, the main body of lath head 29 includes guide pin 49 in FIG. 1C, with cutter blade 39 and set screws 29a that act as blade stabilizer, cutter head 29 also has threaded holes to allow attachment of knob bracket 26 with bolts 27 cutter head base plate 31 attaches to cutter head 29 with bolts 30, cutter head assembly 200 attaches to base plate 32 with bolts 30, material lock down adaptor 33 is attached to base plate 32 with bolts 30, bolts 48 are for holding blade guide springs 36 in position, springs 36 are attach to the shaft of bolt under slight tension and as tension is increased while knob 28 is turned clockwise it thereby reduces vibration and provides stability of the cutter blade 39, return spring 36 provides tension for cutter blade lock guide 37, blade lock and guide 37 has single hole in the center to allow cutter blade to be adjusted and also has two threaded holes that are thru drilled to the center hole and taped for bolts 48 shown in FIG. 1C to lock down the cutter blade 39 in FIG. 1C after adjustment has bee made.

FIG. 1D is an environmental view of the (ML) 100 200 and core drill (CDA) 1000 with attention to the (ROCD) 400 showing mounting to a drill press at the chuck section 620 of drill press 600 indicating that the top portion of (ROC) 400 is mounted underneath the upper portion of the drill 600 and the bottom portion of 400 is on the top of the drill chuck 620

FIG. 1E in top view shows (ROCD) 400 in a closed or neutral position with the bottom view in a opening motion.

FIG. 1F shows an exploded top 57 and bottom 56 view of the (ROCD) 400 sub component parts being the upper arm 57 that is installed underneath the upper portion of the drill press 600 that provides an upper platform for this part, the lower arm 56 provides a lower platform for this component part and is positioned on top of the drill chuck 620 producing a downward force onto the drill chuck 620 in FIG. 1D the power provided for this downward motion is a gas type shock cylinder 58 with a push rod extending at length 58a with the rate of that extension 59a is regulated by a restrictor cylinder 59 with a control valve 61a to adjust the speed of the cut by turning knob 61 counterclockwise to allow opening of 400 or clockwise to stop all motion, see FIG. 1E.

FIG. 2 is an environmental view of the (CD) 300 and oil and coolant tank 310 in motion using a core drill 54 type device producing a machined hole in a plate 700 also producing a useable slug bushing 53 as a byproduct that may be used as bushing or spacers, thereby creating a useful product. The core drill 300 and oilier 310 may also be used at any attack angle by first partially drilling a pilot hole the exact same size as the centering pin 55 that is used in the core bit 54 this partially drilled hole also allows the spring loaded extraction pin 40 in FIG. 2A to act upon the centering pin of the cord drill 54, drilling pilot hole allows larger holes to be drill into odd shapes such pipe without using a repetitive method of using several different standard drill bits until proper size hole is achieved thereby eliminating several steps of that accomplishment.

FIG. 2A is an exploded view of the core drill adaptor 300 showing the sub component parts being in the main core drill shaft 20 which has a thru hole 20b at the extreme top to receive a roll pin 46 that is the retainer for spring 41 that applies pressure onto knock out pin 40 that is restricted from coming out of the shaft 20 by partially a exposed roll pin 47 protruding to the inside hollow 20c of the shaft 20, hole 20a is positioned to align with the lower inside of the oil and coolant tank just above the lower seal 42 and allows oil to continue into and down the main core drill shaft 20 onto the top of the core drill bit 54 core drill and when the pin 40 is compressed against the spring 41oil is allowed to flow into the core drill bit 54 and onto the materials being drilled, or lathed while using the (CDA) 300 for turning purposes. Snap ring 44 fits into snap ring groove 20d in main shaft 20 to hold parts in place, nylon washer 43 runs under snap ring to protect rubber O ring seal 42 below washer which restrains oil and coolant fluid from escaping from top of tank 310.

The (CDA) head 24 shows a roll pin 46 in the top extremity, this roll pin 46 inserts into a partially drill hole 23a shown in FIG. 2B being the bottom cover of reservoir 23 shown in FIG. 2B which allows rotation of the tank along with the (CDA) 300 this rotation causes the tank 310 portion as a unit to become a harmonic balancer to reduce vibration while the machine is working, also note that core (CDA) head 24 has a machined slot 46a cut into the inside to allow oil and coolant to reach the material 700 being worked, material adaptor 38a thru 38h allows a verity of round materials 700 to be lathed, the upper portion of the adaptor 38a -38h is received into the bottom of (CDA) head 24 and has a verity of hole sizes at the opposed end of adaptor 38a-38h to hold materials.

FIG.2B is an exploded view of the oil and coolant tank 310 and it's sub component parts being tank top cap 21 with oil filler hole 21a, main tank reservoir 22, bottom tank cap 23a with partially drill hole 23a that accepts roll pin 46 seen in FIG. 2A, assembly bolts 34, top and bottom caps 21 & 23 are applied with waterproof sealer then assembled with bolts 34, and placed on top of core drill adaptor head 24, with O ring 42 being between (CDA) head 24 and oil and coolant tank 310, O ring 43 is between oil coolant tank and nylon washer 43, then nylon washer 42 is between nylon washer 43 and snap ring 44, then the snap ring is placed into the snap ring grove 20a above washer 43 the main shaft is inserted through assembly into the core drill adaptor head 24 and applying slight pressure the set screws 25 FIG. 2A are then tightened, 20d thereby locking the parts of 300 and 310 into place creating a water tight seal.

I claim:

1. (A). Metal Lathe (B) core drill adaptor with (C) rate of cut device works in combination or as independent devices having combined and or separate functions determined by the user of said devices.

2. Metal Lathe (A) being bolted onto the worktable of standard drill press with connecting bolts that secures this device in a stationary manner to said worktable. Metal Lathe (A) can be used independently without the aid of other devices by locking work piece material into a standard drill press chuck and the opposite end of work piece inserted into a holding device built into Metal Lathe base (A) thereby, when the drill press is turned on, produces a rotating action of said work piece. Whereas the longitudinal cut is controlled by manually rotating the drill press chuck in a downward direction, also, lateral cut is made by adjusting the cut control knob clockwise forcing cut blade into work piece. Metal Lathe (A) having position adjustments, that are in relationship to the standard drill press, being that the cutter head assembly is adjustable in a lateral direction on it's base plate as set out in the specifications of this application. Metal Lathe (A) may also be adjusted in position by means of the mounting bolts. Metal Lathe (A) also may be adjusted in position with the rotating material holding device attached to the base of the Metal Lathe (A).

3. Whereas (A) Metal Lathe by means of a depth of cut controlling device adjustment, being built into the Metal Lathe (A) device, whereas, this adjustment being rotated in a clockwise motion causes pressure to be placed upon a push rod, thus, causing pressure to be transferred onto the cutting blade and thus, causing the cutting blade to be forced onto work piece thereby causing a cutting or lathering process to be established while the work piece is rotating by means of a drill press supplying power to said work piece, thereby possessing the capability of being adjusted in any direction while also incorporating the adjustments of the standard drill press.

4. Whereas (B) Core Drill Adaptor (B) being used as a material holding device in conjunction with Metal Lathe (A) allows work piece materials that are larger than the capacity of a standard drill press chuck, to be lathed using the multiple material adaptor as set forth in specifications. Being, that one end of work piece is inserted into the material holder built into the base of the Metal Lathe (A) and the opposite end of work piece material is inserted into the Core Drill Adaptor (B), at the material adaptor end of the Core Drill Adaptor (B) with the opposite end of the Core Drill Adaptor (B) being inserted and tightened into the chuck portion of the standard drill press. Now, by causing rotation of said work piece using the power supplied by said drill press, work piece is rotated at a rate that allows lathing with the Metal Lathe (A). simutanulesy the work piece material is being cooled and lubricated by a oil and coolant from the tank that is built into the Core Drill Adaptor (B) set out in the specifications in the application.

5. Whereas, the Core Drilling Adaptor (B) being used singularly as a drilling device has a core drill bit inserted and locked into the Core Drill Adaptor (A) at the bit holding end with the opposite end of the Core Drill Adaptor (B) locked into the drill press chuck, with the drill rotating at a proper speed and by actuating a downward motion of the drill press arbor transferees power onto the core bit a thus causes a hole to be effected into the work piece being drilled with oiling and cooling being supplied by the oil and coolant tank which flows thru the Core Drill Adaptor (B) into the core drill bit and in turn onto the work piece material. Holes may be drilled at any angle of attack by adjusting drill press work table to desired angle. Further the Core Drill Adaptor possesses an internal device that allows extraction of the bushing or waste plug (core) generated while drilling takes place. This bushing being a useful product of the drilling process.

6. Whereas, the Rate of Cut Device (C) may be use singularly with a standard drill press in a common drilling method allowing a standard drill press to drill a hole using standard twist type drill bits as to automatically control the rate of decent of the drill chuck that holds the drill bit with out any other attachment and without assistance from an operator.

7. Whereas, the Rate Of Cut Device (C) may be used in duality with Metal Lath (A) Whereby the Rate Of Cut Device (C) automatically controls the decent rate of the drill press chuck thereby controlling the longitudinal cut of the metal lathing process.

8. Whereas, Rate Of Cut Device (C) may be used dually with the Core Bit Adaptor (B) and automatically controls the decent rate of a standard drill press chuck and arbor, thereby controlling the rate of decent of the Core Bit Adaptor (B) while the Core Bit Adaptor (B) is being employed as a drilling device.

9. Whereas, the Rate Of Cut Device (C) being used in a triple application may be used with the Metal Lathe (A) and with the Core Bit adaptor (B) simultaneously thereby controlling the rate of decent of a standard drill press chuck and arbor and rate of downward cut, in a longitudinal perspective in a work piece while using the Metal Lathe (A).
